(19) United States
(12) Patent Application Publication
(10) Pub. No.: US 2012/0313278 A1
(43) Pub. Date: Dec. 13, 2012

(54) MOLDED SINGLE-BLOCK FRAME AND COLLECTOR INCLUDING SAME

(75) Inventors: Hideaki Nishio, Portsmouth (GB); Anis Gaaloul, Carthage (TN); Franck Bollaert, Nimes (FR)

(73) Assignee: SUMIKA POLYMER COMPOUNDS (FRANCE) SA, Saint Martin De Crau (FR)

(21) Appl. No.: 13/264,861

(22) PCT Filed: Apr. 7, 2010
(86) PCT No.: PCT/FR10/00293

§ 371 Date: Jun. 1, 2012

(30) Foreign Application Priority Data
Apr. 17, 2009 (EP) 09005506.2

(51) Int. Cl. B29C 44/02

(52) U.S. Cl. 264/41

(57) ABSTRACT

The invention relates to monobloc frames moulded in an expansible insulating plastic material, particularly frames for moulded insulating collectors. The invention also relates to said collectors, and particularly to moulded insulating collectors for solar thermal or photovoltaic panels.

The invention falls within the field of collectors moulded from plastic materials, optionally foams, insulating materials, capable of use particularly for the production of lightweight solar equipment, such as for example collectors of the flat housing/box type or collectors of the parabolic type.

Solar panels are the basic components of most equipment for the production of solar energy. A solar panel is a device intended to recover a part of the energy from the sun's rays in order to convert it into usable electrical or thermal energy.

Two types of solar panels can be distinguished:
thermal solar panels, or thermal solar collectors, which convert light into heat that is recovered and used in the form of hot water;
photovoltaic solar panels, or photovoltaic modules, which convert light into electricity.

In both cases, the panels are normally flat or parabolic, with a surface area ranging from more or less one square metre to several square metres (for example 2 to 6 square metres). The standard dimensions are generally defined in order to facilitate and optimize the installation.

There are two types of thermal solar panels: water collectors and air collectors.

In the “liquid-type” photothermal solar collectors, the water, or more often a heat transfer fluid (based on glycol for example), circulates in tubes in a closed circuit. In order to obtain an improved yield, the assembly is placed in an insulating glass collector in order to obtain a greenhouse effect.

In the “air type” solar collectors, air circulates and is heated on contact with the absorbers. The air heated in this way is then blown into dwellings for heating or for example into agricultural buildings for drying produce. Here again, use of a collector makes it possible to obtain an improved yield.

Solar thermal technology can be used for applications other than heating premises, such as for example heating fluids in industrial facilities, for example chemical production sites, solar air conditioning of premises, or even seawater desalination.

Photovoltaic solar panels group together photovoltaic cells, which are connected together in series or in parallel. For reasons of solidity among others, these panels also generally comprise a collector.

Some new concept collectors can be of the hybrid (thermal and photovoltaic) type.

Thus, solar panels are generally constituted by an active element (photovoltaic cells or water or air circulation circuit) positioned in a collector, said collector optionally being insulating.

Currently the production of the insulating collectors used in thermal solar panels requires the assembly of at least 6 separate elements, namely a collector, generally formed from a frame made of aluminium or other metal, an insulator, advantageously made of glass wool, a fluid circulation circuit (water or glycol), generally coupled to a heat absorber, itself generally constituted by a metal plate, said absorber being itself suitable for covering with a material that improves its efficiency, and a glass pane.

The frame is in general the part of the collector which absorbs the stresses. In this respect this is therefore the part which requires the closest attention during the design and production phases.

Assembling the different constituent elements of such a solar panel significantly increases its cost and weight. Moreover, increasing the number of assembled base elements can lead to the occurrence of thermal bridges and/or thermal gradients in the structure of the solar panel that can have undesirable consequences such as for example deformation of the assembly, which can result in sealing defects, the occurrence of condensation on the pane or thermal losses that will affect the performance of the equipment.

It would therefore be beneficial to be able to provide a novel collector that does not have the drawbacks of the known collectors of the prior art. One of the objectives of the invention is to propose such a collector.

This objective is achieved according to the invention which proposes to supply a collector at least one part of which, advantageously the frame, is moulded in the form of a monobloc from insulating plastic materials, optionally foamed.

One of the advantages of the invention resides in the fact that the plastic material used to produce the collector can simultaneously be moulded and foamed. Any required shape can be conferred via the moulding, while the foam coating creates an insulation area in the material which makes it possible to further improve the intrinsic insulating character of the material used. Thus it is possible to produce a product having the required shape from a material having, between smooth inner and outer faces, a portion comparable to a solidified foam, these two faces and this foamed portion being made of the same material. The thickness of the foamed portion, when the material is foamed, which is not mandatory, can range from a few tens of millimetres to several centimetres according to need.

In the text hereinbelow the expression “moulded insulating collector” or the term “collector” will be used to denote either a collector according to the invention of which only the frame has been moulded or a collector according to the invention of which the frame and the base have been moulded.

It is therefore understood that according to the invention, the moulded insulating collector can be produced by a single moulding operation in monobloc form of either the frame/base assembly or of the frame alone.

By monobloc is meant according to the invention that the moulded monobloc portion, advantageously the frame but optionally the frame-base assembly, is made of a single piece produced by moulding a single expansible insulating plastic material.

Thus the first subject of the invention is a moulded monobloc frame made of an expansible insulating plastic material, particularly a plastic material the expansion of which can take place during moulding, chosen from plastic materials which can comprise one or more polymers chosen from polypropylene (PP), polyethylene (PE), aliphatic or aromatic polyamide (PA), the mixture of polyphenylene ether (such as polyphenylene ether/polystyrene/butadiene (PPE/PS) alloy, polyphenylene ether/polyphenylene sulphone (PPE/PPS) alloy, polyphenylene ether/polypropylene (PPE/PP) alloy, polyphenylene ether/polyamide (PPE/PA) alloy, polyethersulphone (PES), polyphenylene sulphone (PPS), polyester, polybutylene terephtalate (PBT).

A subject of the invention is also a moulded insulating collector, characterized in that at least the frame of said collector is a moulded monobloc frame such as described previously.

A further subject of the invention is a moulded insulating collector, characterized in that it comprises a moulded monobloc frame and base, moulded in a single piece from a single expansible insulating plastic material, particularly a plastic material the expansion of which can take place during moulding, chosen from the plastic materials which can comprise one or more polymers chosen from polypropylene (PP), polyethylene (PE), aliphatic or aromatic polyamide (PA), the mixture of polyphenylene ether (such as polyphenylene ether/polystyrene/butadiene (PPE/PS) alloy, polyphenylene ether/polyphenylene sulphone (PPE/PPS) alloy, polyphenylene ether/polypropylene (PPE/PP) alloy, polyphenylene ether/polyamide (PPE/PA) alloy, polyethersulphone (PES), polyphenylene sulphone (PPS), polyester, polybutylene terephtalate (PBT).

Preferably according to the invention, the plastic material can be polypropylene, for reasons of low density, cost and recyclability.

Thus by using the plastic materials mentioned previously, it is possible to incorporate the insulation capability directly during moulding by producing foamed plastic walls.

When said moulded insulating collector comprises at least one moulded monobloc frame, it can comprise moreover a base which can be made of any material compatible with the function of the collector, advantageously of the same material as said frame, it being possible to add said base to the frame either by overmoulding of said frame onto said base, or by any means allowing said base to be assembled with said frame, such as for example by bonding after moulding before the constituent material of said frame has solidified, by bonding after moulding when the frame has become stiff, or by any mechanical fixing means such as for example stapling, clipping, screwing, etc. It is also possible for the section of said frame to comprise on one of these faces a sliding fitting produced at the time of moulding, advantageously open towards the inside of the frame, into which it can be envisaged to slide a part such as for example a sheet constituting the base of said collector.

Regardless of the variant of the invention, said collector according to the invention can adopt all required shapes and particularly a parallelepipedic shape, regular or not, comprising a base and four sides or a parabolic shape, having at least one sheet curved along at least one of these axes.

The collectors of the invention make it possible to produce solar thermal panels comprising only three major elements, the insulating collector according to the invention, the water circulation circuit, and the translucent pane, advantageously made of glass.

According to a particular embodiment of the invention, all or part of the plastic material can comprise recycled or regenerated material according to the criteria defined for example in the environmental charters of the automotive industry.

According to also another particular embodiment of the invention, one (or more) reinforcing filler(s) of any type can be added to the plastic material. In this respect mention can be made for example of mineral or organic fillers, nanoparticles, conductive fillers, long or short glass fibres, organic fibres and natural fibres.

Advantageously the use of thermoplastic materials based on natural and/or organic fibres allows for the moulded pieces to be made lighter.

It is also possible to use a mixture of fillers, in order to limit the risks of deformation during moulding. For example, with glass fibre it is possible to use a filler such as for example talc or calcium carbonate.

Thermoplastic materials incorporating fillers can be chosen for example from the Thermofil® range made by Sumika Polymer Compounds.

According to yet another embodiment of the invention, it is possible to add at least one flame-retardant filler to the thermoplastic material, with or without halogens, in order to add fire protection.

Another great advantage of the invention is that it allows collectors to be produced from thermoplastic material, having large dimensions, optionally flat, showing practically no residual deformations after moulding. To the knowledge of the applicant, the conventional plastic injection-moulding techniques known from the prior art make it difficult to produce large flat collectors that do not have such residual deformations.

Another advantage of the invention comes from the fact that the materials and techniques described previously are used for its production, making it possible not only to give any shape to the frame or collector but also any dimension to said frame or collector. The latter can without difficulty be adapted to need.

Optionally said collector can moreover comprise other incorporated elements, for example made of plastics, and optionally integrated features.

Thus, the invention allows for flat or parabolic collectors to be produced that can easily incorporate all sorts of additional elements in order to improve the performance of the solar panel. For example it can be possible to incorporate a solar reflector within the collector according to the invention, for example a solar reflector, in the form of a parabolic arrangement, each arrangement of which can correspond to a fluid circulation tube. This additional element makes it possible to reproduce and improve the principle of the open parabolic collector (without a box).

Yet another advantage of the invention is that the process allowing for the manufacture of the solar thermal panels according to the invention, which is also a subject of the present invention, allows for direct incorporation of features essential to the satisfactory operation of a solar panel, whereas in the techniques of the prior art, these features are generally added onto the solar panel after its manufacture.

It is also possible, during moulding of the collector, to incorporate one or more means for fixing the pane of a solar thermal panel, whether organic or mineral, by producing during moulding a sliding fitting advantageously open towards the inside of the frame or also by overmoulding of fixing means, for example clips.

It is also possible to incorporate by overmoulding during moulding of the collector, one or more sealing means such as gaskets, for example made of elastomer, during moulding of the collector (for example gaskets made of thermoplastic elastomers such as for example made of olefin thermoplastics, dynamically vulcanized (TPV) or otherwise (TPO) such as for example those sold under the trade marks Espolex® (Sumitomo Chemical) or Santoprene®.

It is also possible to incorporate into the collector one or more means of absorbing the sun's rays, by producing absorbers, for example extruded from plastic materials (polyphenylene sulphide (PPS), polyphenylene ether/polystyrene/butadiene (PPE/PS) alloy, aromatic polyamides, Polysulphone, polyester sulphones, etc) and/or plastic films on the surface of an absorber that is itself made of metal for example aluminium or copper).

It is also possible to incorporate, during moulding of the collector, one or more means of fastening the collector to a support, for example a roof, with the possibility of varying the inclination of said supports in order to increase the efficiency of the solar panel.

The collectors according to the invention can be bulk-dyed, for example by master batches during the moulding stage or by decoration pre-applied in the mould using a decorative film.

As the collectors can adopt any shapes required, it is also possible to produce collectors, and therefore solar thermal panels, that could be incorporated into their support such as for example the facade of a building.

In the case of solar collectors with a collector having a parabolic shape in which the tube or tubes are not enclosed in a box, the plastic material used for its production can be covered by a reflective or absorbent film.

According to yet another embodiment of the invention, and in order to make the solar panel lighter, an organic pane can be used to replace the mineral pane. This organic pane can be chosen from methyl polymethacrylates (PMMA), whether or not reinforced against impact by of other acrylates such as butyl acrylates, or also polycarbonates (PC).

According to yet another embodiment of the invention, additional means of insulation and/or means of thermal protection of the walls can be added if necessary.

According to the invention, the moulding of the collector is suitable for production by any known process comprising at least one stage of moulding the insulating material and one stage of expansion of said insulating material.

In this respect there will be mentioned for example
conventional thermoplastic injection moulding, preferably at low pressure, such as the SPMold process by Sumitomo Chemical. This process has the great advantage of avoiding any deformation effect after moulding.
thermoplastic injection moulding with foaming of the plastic material such as for example the SP Foaming process. The foaming of the plastic material can be obtained by adding a chemical expansion agent to the plastic material to be injected. Said chemical expansion agent can be chosen preferably from the suppliers Sekuisi or Clariant.
the Dolphin process;
the Mucell process by the company TREXEL, during which a gas in supercritical state is injected into the melted plastic material;
thermoforming of sheets that are extruded and foamed by direct extrusion such as for example the Sumiceller or Trocellen processes.

Advantageously according to the invention, the SP-Mold and Sumiceller® processes, developed by Sumitomo Chemical, will be used.

According to a variant of the invention, it is possible to add, by overmoulding of the elements attached to the collector, such as for example a base in the variant where only the frame is moulded as a monobloc, or also whatever the variant, locking clips, reinforcements, or any other element capable of being obtained by overmoulding. A preferred overmoulding technique can be thermoplastic injection moulding of plastic materials based on polypropylene.

According to another embodiment of the invention, the inner and outer surfaces of the collector can be independently or simultaneously coated with a material intended to provide good reflection and/or thermal protection, such as for example a protective film and/or an aluminized film. According to this embodiment, the film can be affixed by deposition in the mould during the process of moulding by injection or thermoforming or by coextrusion in the case of extruded parabolic collectors.

The invention also relates to thermal solar panels intended to heat water or air as well as photovoltaic solar panels, comprising at least one collector according to the invention.

One of the great advantages of the solar thermal panels according to the invention resides in the fact that they can be produced from 3 elements only (the collector according to the invention, the water or air circuit and the organic or mineral glass pane), which causes a significant reduction in the assembly time of the panel as well as a significant reduction in the weight (of 10 to 80%) depending to the features incorporated into the collector. It will be noted that the use of an organic glass to replace a mineral glass can also allow a significantly greater weight reduction (−50%). These savings increase the ease of transport as well as installation linked to the weight reduction, resulting in reduced costs as well as a lower CO2 impact on the environment.

The occurrence of thermal bridges is also significantly reduced in collectors and/or solar panels according to the invention.

Another advantage of the invention resides in the fact that the solar panels incorporating a collector according to the invention can have a relatively reduced thickness, as the insulation forms an integral part of said collector.

The ease of dismantling (linked to the reduced number of components or sub-assemblies of components) of the collectors according to the invention facilitates the recycling of said components, in particular with the use of plastic materials based on polypropylene, which do not give off toxic substances.

The reduction of the impact on the environment linked to the elimination of surface treatments and painting of the collector, since it is possible to decorate the panels by bulk-dying or lamination of plastic or aluminized films, is moreover significant, compared with the current solution of painted aluminium frames.

Finally, the freedom of shape that the design of parts made of thermoplastic materials allows should enable improved incorporation of the solar equipment into its environment (for example, incorporation into facades or on the roof of a building). In this respect, there is a possibility of designing the collector as a box of a different shape, incorporating the support for the collector into its shape. This box can be produced from a sheet of foamed plastic material which would be folded at different points in order to produce the required shape. The box of different shape that is produced in this way can also incorporate other elements such as a siphon tank in the case of a siphon solar thermal panel, a fuse box in the case of a photovoltaic panel, an air conditioning housing or heat pump for an improved integration of the set of additional items of equipment currently present on the roof of a house for example.

Advantageously, said solar thermal panel can moreover comprise, independently or simultaneously, one or more support(s) for the water or air circuits, one or more reinforcing element(s), one or more support(s) for the glass pane, one or more additional insulating material(s), one or more heat absorber(s), generally constituted by a metal plate, said absorber itself being suitable for covering with a material that improves its performance, said absorber also capable of being coupled to the water or air circuit.

A subject of the invention is also the use of a collector according to the invention for mounting solar thermal or photovoltaic panels.

A person skilled in the art understands that the techniques used in the present invention and the applicable dimensions are data that are commonplace in these fields, and will have no difficulty in implementing them.

Other advantages, aims and features of the present invention will become apparent from the non-limitative description hereinafter, given for the purposes of explanation only, with reference to the attached drawings in which:

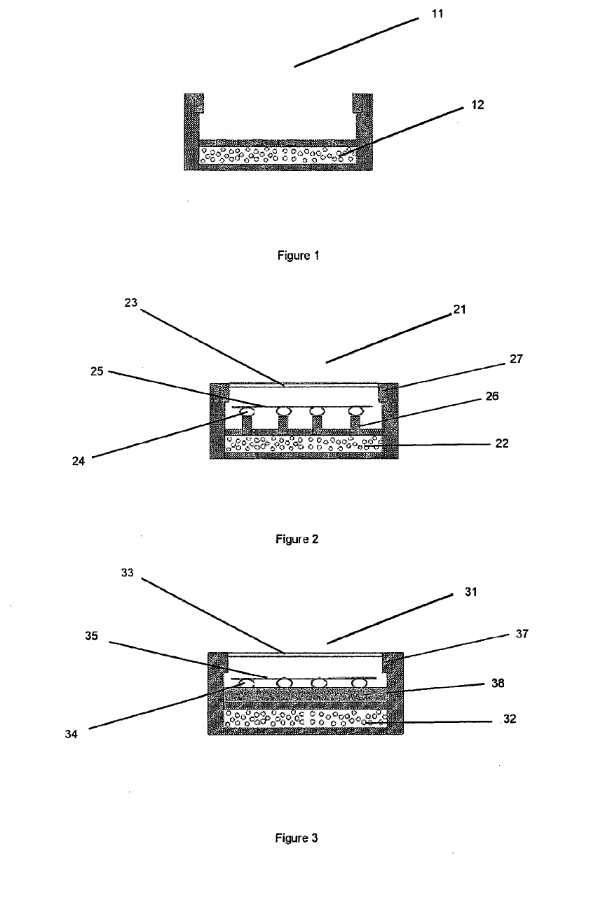

FIG. 1 shows a diagrammatic cross section of a collector according to the invention;

FIG. 2 shows a cross section view of a solar panel intended for heating water.

FIG. 3 shows a cross section view of a solar panel intended for heating water, also incorporating additional insulation.

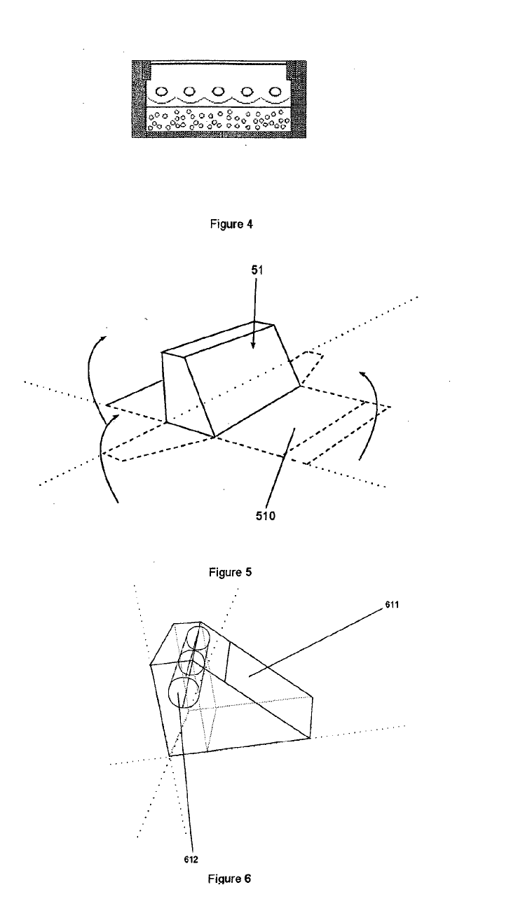

FIG. 4 shows a cross-section view of a solar panel intended for heating water, incorporating moreover another solar collector.

FIG. 5 shows a 3-dimensional view of a collector according to the invention in the form of a box.

FIG. 6 shows a 3-dimensional transparent view of a solar thermal panel incorporated into a collector as shown in FIG. 5.

Thus by way of reference to the figures, FIG. 1 is a cross section view of a collector (11) according to the invention incorporating an insulator (12) in its base.

FIG. 2 is a cross section view of a thermal solar panel intended for heating water comprising a collector according to the invention (21) incorporating an insulator (22) in its base, a glass pane (23), a water circuit (24) a heat absorber (25), water circuit supports (26) and overmoulded means of support for the glass pane (27).

FIG. 3 is a cross section view of a thermal solar panel according to FIG. 2, intended for heating water, comprising moreover an additional insulator (38).

FIG. 4 is a cross section view of a thermal solar panel according to FIG. 2, intended for heating water, comprising moreover a solar reflector (49) in the form of a parabolic arrangement, each arrangement of which can correspond to a fluid circulation tube (44).

FIG. 5 shows a 3-dimensional view of a collector according to the invention in the form of a box (51) and a representation of the sheet made of insulating plastic material (510) from which said box was formed by folding. The arrows indicate the direction of folding of the sheet of foamed plastic material.

FIG. 6 is a 3-dimensional view of a solar panel installed in a collector according to FIG. 5, transparently showing a solar panel (611) and a tank (612).

1. Moulded monobloc frame in an expansible insulating plastic material, particularly a plastic material the expansion of which can take place during moulding, chosen from the plastic materials which can comprise one or more polymers chosen from polypropylene (PP), polyethylene (PE), aliphatic or aromatic polyamide (PA), the mixture of polyphenylene ether (such as polyphenylene ether/polystyrene/butadiene (PPE/PS) alloy, polyphenylene ether/polyphenylene sulphone (PPE/PPS) alloy, polyphenylene ether/polypropylene (PPE/PP) alloy, polyphenylene ether/polyamide (PPE/PA) alloy, polyethersulphone (PES), polyphenylene sulphone (PPS), polyester, polybutylene terephtalate (PBT), advantageously polypropylene.

2. Moulded insulating collector, characterized in that it comprises at least one moulded monobloc frame according to claim 1.

3. Moulded insulating collector, characterized in that it comprises a moulded monobloc frame and base, moulded in a single piece from a single expansible insulating plastic material, particularly a plastic material the expansion of which can take place during moulding, chosen from the plastic materials which can comprise one or more polymers chosen from polypropylene (PP), polyethylene (PE), aliphatic or aromatic polyamide (PA), the mixture of polyphenylene ether (such as polyphenylene ether/polystyrene/butadiene (PPE/PS) alloy, polyphenylene ether/polyphenylene sulphone (PPE/PPS) alloy, polyphenylene ether/polypropylene (PPE/PP) alloy, polyphenylene ether/polyamide (PPE/PA) alloy, polyethersulphone (PES), polyphenylene sulphone (PPS), polyester, polybutylene terephtalate (PBT), advantageously polypropylene.

4. Collector according to claim 2, characterized in that it comprises moreover a base.

5. Collector according to claim 4, characterized in that said base is added to the frame either by overmoulding of said frame onto said base, or by any means allowing said base to be assembled with said frame, such as for example by bonding after moulding before the material constituting said frame has solidified, by bonding after moulding when the frame has become stiff, or by any mechanical fixing means such as for example stapling, clipping, screwing.

6. Frame according to claim 1 or collector according to any one of claims 2 to 5, characterized in that one or more reinforcing filler(s) and/or one or more fire retardant filler(s) is (are) added to the plastic material.

7. Frame or collector according to claim 6, characterized in that the reinforcing filler is chosen from mineral or organic fillers, nanoparticles, conductive fillers, long or short glass fibres, organic fibres, natural fibres, preferably natural and/or organic fibres.

8. Collector according to any one of claims 2 to 7, characterized in that it comprises moreover, simultaneously or independently, a solar reflector, a means of insulation or a means of thermal protection of the walls, one or more means for fixing a pane, one or more sealing means, one or means of absorbing the sun's rays, one or more means of fixing the collector onto a support.

9. Collector according to any one of claims 2 to 8, characterized in that it is suitable for production by conventional thermoplastic injection moulding, preferably at low pressure, (the SPMold process by Sumitomo Chemical), thermoplastic injection moulding with foaming of the plastic material (SP Foaming process), the Dolphin process, the Mucell process, thermoforming of extruded, foamed sheets by direct extrusion (Sumiceller or Trocellen processes).

10. Collector according to claim 9, characterized in that it is suitable for production by the SP-Mold and Sumiceller® techniques.

11. Solar thermal or photovoltaic or mixed panel comprising at least one frame according to claim 1, 6 or 7 or at least one collector such as described in any one of claims 2 to 10.

12. Solar thermal panel according to claim 10, characterized in that it comprises moreover a water circulation circuit and a translucent sheet.
